(19) United States
(12) Patent Application Publication
(10) Pub. No.: US 2023/0021274 A1
(43) Pub. Date: Jan. 19, 2023

(54) AUXILIARY RANGE EXTENSION FOR BATTERY ELECTRIC VEHICLE

(71) Applicants: Chad BURCHETT, Browns Summit, NC (US); VOLVO TRUCK CORPORATION, Goteborg (SE)

(72) Inventor: Chad BURCHETT, Browns Summit, NC (US)

(73) Assignee: VOLVO TRUCK CORPORATION, Goteborg (SE)

(21) Appl. No.: 17/757,344

(22) PCT Filed: Jan. 15, 2020
(86) PCT No.: PCT/US2020/013612

§ 371 Date: Jun. 14, 2022

(51) Int. Cl. B60L 58/22; B60L 53/00; B60L 7/18; B60L 50/60; B60L 58/12

(52) U.S. Cl. CPC B60L 58/22; B60L 53/00; B60L 7/18; B60L 50/66; B60L 58/12

(57) ABSTRACT

A system and method for charging a battery electric vehicle having a tractor and a trailer. The system may include a regenerative braking system configured to generate energy during deceleration of the battery electric vehicle, a tractor side battery pack, a trailer side battery pack, an inductive charging device configured to transfer energy between the tractor side battery pack and the trailer side battery pack, and a battery management system. The battery management system is configured to control a flow of energy between the regenerative braking system, the tractor side battery pack, and the trailer side battery pack based on a state of charge of the tractor side battery pack, a state of charge of the trailer side battery pack, or both the state of charge of the tractor side battery pack and the state of charge of the trailer side battery pack.

### TECHNICAL FIELD

Embodiments of the present disclosure relate generally to a system and method for charging a battery in a battery electric vehicle, and more specifically, to a system and method for charging a battery in aa battery electric vehicle having a tractor and a trailer.

### BACKGROUND

Currently, battery electric vehicles (BEVs) are limited to the number of battery packs that can be carried on the BEV due to space and weight constraints. These limits are due in part to legal load limits. The limited number of battery packs in turn limits the capacity and range (e.g., range of travel) of the BEV. Current solutions to increase the range include stationary charging stations. That is, parking the BEV in a designated charging station where the battery packs may be charged. The designated charging stations may require a CCS1 or CCS2 charging plug or may be an OPPCharge overhead pantograph. In either case, the BEV is stationary during the charging time period. Therefore, a need exists to allow a BEV to increase the range while the BEV is motion and is not confined to being stationary.

### BRIEF SUMMARY

According to an embodiment, a system for charging a battery electric vehicle having a tractor and a trailer may include a regenerative braking system configured to generate energy during deceleration of the battery electric vehicle; a tractor side battery pack; a trailer side battery pack; an inductive charging device configured to transfer energy between the tractor side battery pack and the trailer side battery pack; and a battery management system, wherein the battery management system is configured to control a flow of energy between the regenerative braking system, the tractor side battery pack, and the trailer side battery pack based on a state of charge of the tractor side battery pack, a state of charge of the trailer side battery pack, or both the state of charge of the tractor side battery pack and the state of charge of the trailer side battery pack.

According to an embodiment, a method for charging a battery electric vehicle having a tractor and a trailer while the battery electric vehicle is in motion may include determining a state of charge of a tractor side battery pack; determining a state of charge of a trailer side battery pack; transferring energy from the trailer side battery pack or from a regenerative braking system to the tractor side battery pack based on the state of charge of the tractor side battery pack being below a predetermined level; and transferring energy from the regenerative braking system to the trailer side battery pack based on the state of charge of the tractor side battery pack being above a predetermined level and the state of charge of the trailer side battery pack being below a predetermined level.

According to an embodiment, a vehicle may include a tractor; a trailer coupled to the tractor; a first battery pack on the tractor; a second battery pack on the trailer; an inductive charging device configured to transfer energy between the first battery pack and the second battery pack; and a control system including a microprocessor, the control system configured to: determine a state of charge of the first battery pack, determine a state of charge of the second battery pack, transfer energy from a regenerative braking system or from the second battery pack to the first battery pack if the state of charge of the first battery pack is below a predetermined level, transfer energy from the regenerative braking system to the second battery pack if the state of charge of the first battery pack is above a predetermined level and the second battery pack is below a predetermined level, and disable the regenerative braking system thus stopping generation of energy if the state of charge of the first battery pack is above a predetermined level and the state of charge of the second battery pack is above a predetermined level.

### ASPECTS OF THE INVENTION

According to an embodiment, a system for charging a battery electric vehicle having a tractor and a trailer may include a regenerative braking system configured to generate energy during deceleration of the battery electric vehicle; a tractor side battery pack; a trailer side battery pack; an inductive charging device configured to transfer energy between the tractor side battery pack and the trailer side battery pack; and a battery management system, wherein the battery management system is configured to control a flow of energy between the regenerative braking system, the tractor side battery pack, and the trailer side battery pack based on a state of charge of the tractor side battery pack, a state of charge of the trailer side battery pack, or both the state of charge of the tractor side battery pack and the state of charge of the trailer side battery pack.

According to an embodiment, the inductive charging device comprises a first inductive charging pad on the tractor and a second inductive charging pad on the trailer.

According to an embodiment, the first inductive charging pad is mounted on an upward facing surface of a rear section of the tractor and the second inductive charging pad is mounted on a downward facing surface in a forward section of the trailer, and wherein the first inductive charging pad and the second inductive charging pad are aligned with the first inductive charging pad located below the second inductive charging pad when the tractor and the trailer are in an axially straight alignment.

According to an embodiment, the first inductive charging pad and the second inductive charging pad each comprise more than one inductive charging pad.

According to an embodiment, the trailer side battery pack is mounted on a lower surface of the trailer.

According to an embodiment, the battery management system is configured to: determine the state of charge of the tractor side battery pack; and request energy from the regenerative braking system or from the trailer side battery pack if the state of charge is below a predetermined level.

According to an embodiment, the battery management system is configured to: transfer energy from the regenerative braking system or from the trailer side battery pack to the tractor side battery pack if the state of charge of the tractor side battery pack is below a predetermined level; transfer energy from the regenerative braking system to the trailer side battery pack if the state of charge of the tractor side battery pack is above a predetermined level and the trailer side battery pack is below a predetermined level; and disable the regenerative braking system thus stopping generation of energy if the state of charge of the tractor side battery pack is above a predetermined level and the state of charge of the trailer side battery pack is above a predetermined level.

According to an embodiment, the predetermined level of the tractor side battery pack and the predetermined level of the trailer side battery pack each represent a fully charged state for the respective battery pack.

According to an embodiment, the system is configured to operate while the battery electric vehicle is in motion.

According to an embodiment, the system further comprising a switch, the switch configured to control the flow of energy between the regenerative braking system, the tractor side battery pack, and the trailer side battery pack.

According to an embodiment, the system further comprising a brake resistor configured to discharge energy generated by the regenerative braking system when the state of charge of the tractor side battery pack and the state of charge of the trailer side battery pack are each at a fully charged state.

According to an embodiment, a method for charging a battery electric vehicle having a tractor and a trailer while the battery electric vehicle is in motion may include determining a state of charge of a tractor side battery pack; determining a state of charge of a trailer side battery pack; transferring energy from the trailer side battery pack or from a regenerative braking system to the tractor side battery pack based on the state of charge of the tractor side battery pack being below a predetermined level; and transferring energy from the regenerative braking system to the trailer side battery pack based on the state of charge of the tractor side battery pack being above a predetermined level and the state of charge of the trailer side battery pack being below a predetermined level.

According to an embodiment, the method further comprising disabling the regenerative braking system based on the state of charge of the tractor side battery pack and the state of charge of the trailer side battery pack.

According to an embodiment, the method further comprising transferring energy with an inductive charging device having a first inductive charging pad mounted on the tractor in axial alignment with a second inductive charging pad mounted on the trailer.

According to an embodiment, the method further comprising mounting the first inductive charging pad to an upward facing surface of a rear section of the tractor and mounting the second inductive charging pad to a downward facing surface in a forward section of the trailer.

According to an embodiment, the predetermined level of the tractor side battery pack and the predetermined level of the trailer side battery pack each represent a fully charged state for the respective battery pack.

According to an embodiment, the predetermined level of the tractor side battery pack is 80% of a rated capacity of the tractor side battery pack and the predetermined level of the trailer side battery pack is 80% of a rated capacity of the trailer side battery pack.

According to an embodiment, the method further comprising performing the method while the battery electric vehicle is in motion.

According to an embodiment, the method further comprising balancing energy generated by the regenerative braking system between the tractor side battery pack and the trailer side battery pack.

According to an embodiment, a vehicle may include a tractor; a trailer coupled to the tractor; a first battery pack on the tractor; a second battery pack on the trailer; an inductive charging device configured to transfer energy between the first battery pack and the second battery pack; and a control system including a microprocessor, the control system configured to: determine a state of charge of the first battery pack, determine a state of charge of the second battery pack, transfer energy from a regenerative braking system or from the second battery pack to the first battery pack if the state of charge of the first battery pack is below a predetermined level, transfer energy from the regenerative braking system to the second battery pack if the state of charge of the first battery pack is above a predetermined level and the second battery pack is below a predetermined level, and disable the regenerative braking system thus stopping generation of energy if the state of charge of the first battery pack is above a predetermined level and the state of charge of the second battery pack is above a predetermined level.

### BRIEF DESCRIPTION OF DRAWINGS

The description below refers to the following drawings of which:

FIG. 1 shows a battery electric vehicle with a battery pack, according to an embodiment of the disclosure;

FIG. 2 shows a flow diagram, according to an embodiment of the disclosure; and

FIG. 3 shows a flow diagram, according to an embodiment of the disclosure.

### DETAILED DESCRIPTION

The present disclosure relates to a battery electric vehicle (BEV) that may include one or more battery packs. The one or more battery packs may be charged while the BEV is in motion. In some cases, the BEV may include a tractor and a trailer. Each of the tractor and the trailer may include one or more battery packs. The BEV may include an inductive charging device that is configured to transfer energy between the one or battery packs on the tractor and the trailer. A battery management system may control the direction of flow of the energy and ensure that the battery packs are properly charged. The battery packs may be charged with a regenerative braking system of the BEV. The ability of the BEV to charge, manage, and optimize the state of charge of the battery packs while the BEV is in motion may allow for the BEV to have increased range as compared to prior art BEV while minimizing downtime of the BEV.

Details of exemplary systems and methods to achieve the aforementioned advantages and benefits are described herein. However, alternatives to the structure, layout, shape, size, arrangement, etc., are contemplated without departing from the goals of charging the BEV.

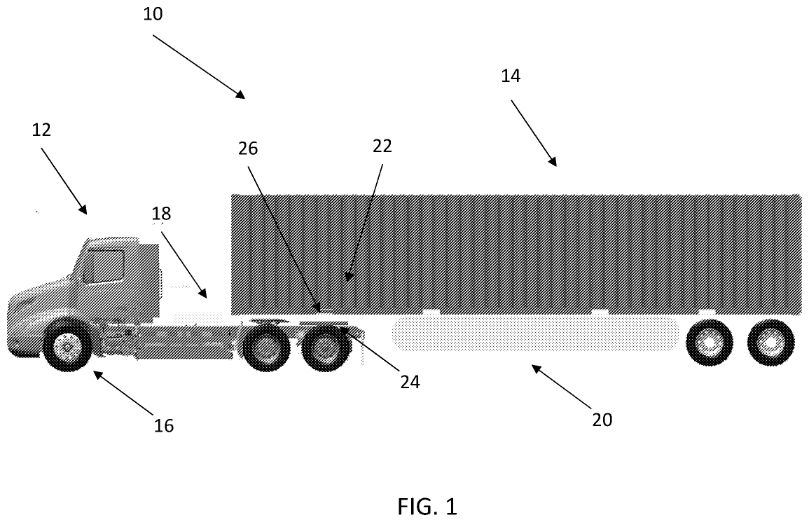

Referring to FIG. 1, a vehicle 10 is shown. The vehicle 10 may be a BEV. The vehicle 10 may be a BEV having a tractor 12 and a trailer 14. The tractor 12 may include a regenerative braking system 16. The regenerative braking system 16 may include an electric motor mounted or coupled to the axles or wheels of the tractor 12 to create regenerative energy. The regenerative braking system 16 may create regenerative energy during deceleration of the vehicle 10 thus creating power to be stored as potential energy by the vehicle 10. The regenerative braking system 16 may be any known regenerative braking system that is capable of generating energy during the braking of a vehicle.

The tractor 12 may include one or more battery packs 18. The battery packs 18 may be coupled to a chassis of the tractor 12. The trailer 14 may include one or more battery packs 20. The battery packs 20 may be coupled to an underside of the trailer 14. The battery packs 18 and/or the battery packs 20 may store energy to be supplied to the tractor 12 and/or the trailer 14. For example, the battery packs 18, 20 may store energy used for propulsion of the tractor 12, for powering the trailer 14 (e.g., for a refrigerated trailer), or both. Although shown mounted to the chassis of the tractor 12 and the underside of the trailer 14, the battery packs 18, 20 may be mounted in any location on the tractor 12 and trailer 14.

With continued reference to FIG. 1, the vehicle 10 may include an induction charging device 22. The induction charging device 22 may include a first inductive charging pad 24 on the tractor 12 and a second inductive charging pad 26 on the trailer 14. The induction charging device 22 may allow for transfer of energy between the battery packs 18 and 20. That is, the induction charging device 22 may allow for transfer of energy from battery pack 18 to battery pack 20 and from battery pack 20 to battery pack 18. The induction charging device 22 may allow for transfer of energy from the regenerative braking system 16 to the battery pack 20.

The first inductive charging pad 24 may be coupled or mounted on an upward facing surface of a rear section of the tractor 12. The second inductive charging pad 26 may be coupled or mounted on a downward facing surface in a forward section of the trailer 14. The first inductive charging pad 24 and the second inductive charging pad 26 may be mounted in such a manner that they are generally aligned when the tractor 12 and the trailer 14 are in an axially aligned position. The first inductive charging pad 24 and the second inductive charging pad 26 may be aligned such that the first inductive charging pad 24 is located below the second inductive charging pad when the tractor 12 and the trailer 14 are in an axially straight alignment.

Although depicted as a single inductive charging pad, each of the inductive charging pads 24, 26 may comprise a plurality of inductive charging pads. Where a plurality of inductive charging pads are provided for each of inductive charging pads 24, 26, each of the plurality of inductive charging pads on the tractor may be aligned with a respective inductive charging pad on the trailer. The inductive charging pads 24, 26 may be located in a manner such that they do not interfere with the other components of the vehicle 10. For example, the inductive charging pad 24 may be placed around the kingpin such that the kingpin does not interfere with the transmission of energy between the inductive charging pads 24, 26.

The vehicle 10 may be provided with a battery management system (not visible in FIG. 1). The battery management system may monitor and control the regenerative braking system 16, the battery pack 18, and the battery pack 20. The battery management system may monitor a state of charge (SOC) of the battery packs 18, 20. Based on a condition of the SOC of the battery packs 18, 20, a desired range of the vehicle, a desired operation of the tractor and/or trailer (e.g., if there is a refrigeration unit), or combinations thereof, the battery management system may direct or control flow of energy between the regenerative braking system 16 and the battery packs 18, 20, as will be described in more detail to follow.

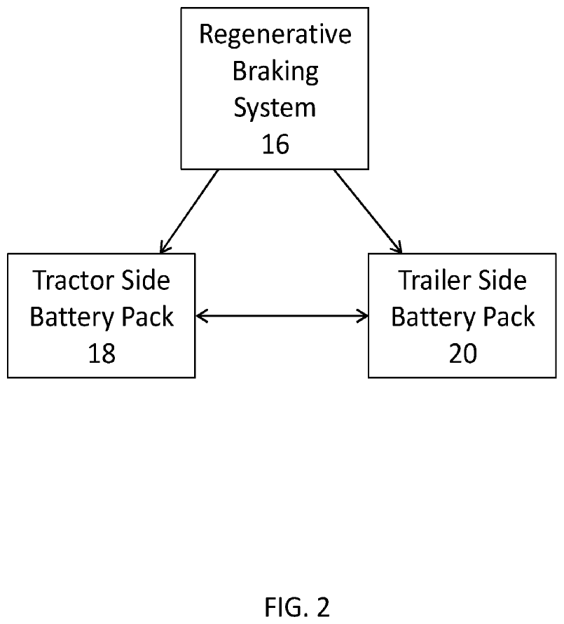

Referring to FIG. 2, a diagram of energy flow is shown. The regenerative braking system 16 may provide energy generated by the regenerative braking system 16 to the battery pack 18 and to the battery pack 20. When providing energy to the battery pack 20, the energy may be transferred from the regenerative braking system 16 through the inductive charging device 22 (FIG. 1) and to the battery pack 20. The battery pack 18 may transfer energy to the battery pack 20 and vice versa (e.g., the battery pack 20 may transfer energy to the battery pack 18). Where and when the energy is provided between the various components of the vehicle 10 may be determined and controlled by the battery management system.

Each of the battery packs 18, 20 may include a sensor for determining the state of charge (SOC) of the respective battery pack 18, 20. The SOC may be transmitted or communicated to the battery management system. The battery management system may monitor the SOC of the battery packs 18, 20 and control the energy flowing to the battery pack 18, 20 and/or from the regenerative braking system 16. The battery management system may control the flow of energy such that the battery packs 18, 20 maintain a SOC below a predetermined value.

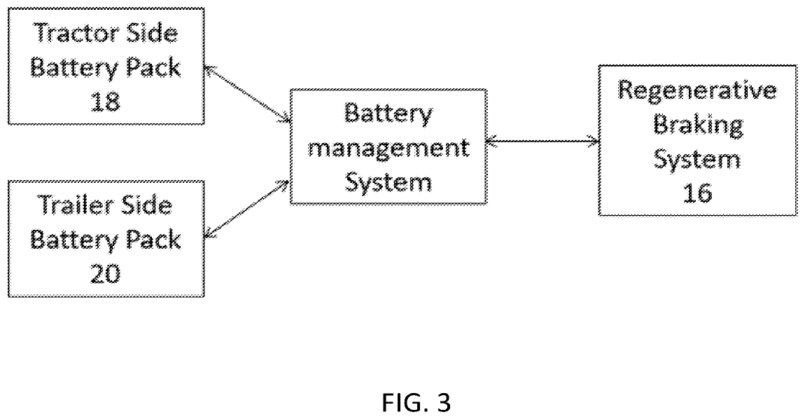

Referring to FIG. 3, the battery management system may control the flow of energy between the regenerative braking system 16, the battery pack 18, and the battery pack 20. The control of the flow of energy may be based on the SOC of the battery pack 18, the SOC of the battery pack 20, or the SOC of both the battery pack 18 and the battery pack 20.

In use, the battery management system may determine the SOC of the battery pack 18 and, if the SOC is below a predetermined level, the battery management system may request energy from the regenerative braking system 16 and/or from the battery pack 20. The regenerative braking system 16 and/or the battery pack 20 may then transmit energy to the battery pack 18.

The battery management system may determine the SOC of the battery pack 18 and, if the SOC is below a predetermined level, the battery management system may request energy from the regenerative braking system 16 and/or from the battery pack 18. The regenerative braking system 16 and/or the battery pack 18 may then transmit energy to the battery pack 20.

The battery management system may determine the SOC of both the battery packs 18 and 20. If the SOC of the battery pack 18 is below a predetermined level and the battery pack 20 is at or above a predetermined level, the battery management system may request and transfer energy from the battery pack 20 to the battery pack 18. This may be in addition to or in lieu of energy being requested and transferred from the regenerative braking system 16. Once the battery pack 18 is charged to the desired SOC, the battery management system may then request and transfer energy from the regenerative braking system 16 to the battery pack 20. This may result in both battery packs 18, 20 being of optimum SOC.

The battery management system may determine the SOC of both the battery packs 18 and 20. If the SOC of the battery pack 18 is below a predetermined level and the battery pack 20 is below a predetermined level, the battery management system may request and transfer energy from the regenerative braking system 16 to both the battery packs 18 and 20. The battery management system may be able to prioritize the battery pack receiving energy based on the SOC or the capability desired (e.g., if the propulsion battery is low, the battery management system may first charge this battery to reduce interruptions to the motion of the vehicle). By providing energy to both battery packs, this may result in both battery packs 18, 20 being of optimum SOC.

The battery management system may determine the SOC of both the battery packs 18 and 20. If the SOC of the battery pack 18 is at or above a predetermined level and the battery pack 20 is below a predetermined level, the battery management system may request and transfer energy from the battery pack 18 to the battery pack 20. This may be in addition to or in lieu of energy being requested and transferred from the regenerative braking system 16. Alternatively, the battery management system may not transfer energy from the battery pack 18, leaving the battery pack 18 at the preferred SOC, and may instead request and transfer energy from the regenerative braking system 16 to the battery pack 20. This may result in both battery packs being of optimum SOC.

The battery management system may determine the SOC of both the battery packs 18 and 20. If the SOC of the battery pack 18 is at or above a predetermined level and the battery pack 20 is at or above a predetermined level, the battery management system may disable the regenerative braking system 16. This may prevent overcharging and potential damage to the battery packs 18, 20.

In other words, the battery management system may be configured to 1) transfer energy from the regenerative braking system or from the trailer side battery pack to the tractor side battery pack if the state of charge of the tractor side battery pack is below a predetermined level, 2) transfer energy from the regenerative braking system to the trailer side battery pack if the state of charge of the tractor side battery pack is above a predetermined level and the trailer side battery pack is below a predetermined level, 3) disable the regenerative braking system thus stopping generation of energy if the state of charge of the tractor side battery pack is above a predetermined level and the state of charge of the trailer side battery pack is above a predetermined level, or any combination thereof.

The predetermined, desired, or optimum level of the battery packs may represent a fully charged state of the respective battery pack. In one example, the predetermined value may be 80% of a rated capacity of the battery pack.

According to the present disclosure, the battery management system may allow for battery charging during operation of the vehicle, e.g., while the battery electric vehicle is in motion.

During charging of the vehicle 10 of FIG. 1, a method may determine a state of charge of a tractor side battery pack, determine a state of charge of a trailer side battery pack, transfer energy from the trailer side battery pack or from a regenerative braking system to the tractor side battery pack based on the state of charge of the tractor side battery pack being below a predetermined level; and transfer energy from the regenerative braking system to the trailer side battery pack based on the state of charge of the tractor side battery pack being above a predetermined level and the state of charge of the trailer side battery pack being below a predetermined level.

The method of charging the vehicle may also include disabling the regenerative braking system based on the state of charge of the tractor side battery pack and the state of charge of the trailer side battery pack.

The energy may be transferred from the tractor to the trailer with an inductive charging device having a first inductive charging pad mounted on the tractor in axial alignment with a second inductive charging pad mounted on the trailer. The first inductive charging pad may be mounted to an upward facing surface of a rear section of the tractor and the second inductive charging pad may be mounted to a downward facing surface in a forward section of the trailer.

The battery management system may balance energy generated by the regenerative braking system between the tractor side battery pack and the trailer side battery pack. Communication between the battery management system, the battery packs, and the regenerative braking system may be provided with one or more communication cables.

A switch may be provided to control the flow of energy between the regenerative braking system, the tractor side battery pack, and the trailer side battery pack. The switch may be a bidirectional switch allowing flow in more than one direction. According to embodiments of the present disclosure, high voltage 660V orange cables may transmit the power through a charge switch unit which may allow the bidirectional flow of power in one direction or the other based on the state of charge of the batteries in the system.

A brake resistor may be provided to discharge energy generated by the regenerative braking system when the state of charge of the tractor side battery pack and the state of charge of the trailer side battery pack are each at a fully charged state.

Although the present disclosure describes energy generation by means of a regenerative braking system, alternative energy generation systems that are capable of generating energy and transferring the energy to a battery pack may be provided.

The present disclosure allows a trailer with an electric motor mounted to the axles or wheel ends to create regenerative power during deceleration of the combined vehicle thus creating power to be stored as potential energy to the trailer battery packs or truck/tractor battery packs.

According to the present disclosure, the trailer may be able to understand when the accelerator of the vehicle is no longer being depressed via a communication cable between truck and trailer as well as percentage of regenerative power requested depending on the SOC of the battery packs. Power or energy may be transmitted between truck and trailer via the inductive charging device located on the chassis frame of the truck or internally via the fifth wheel top place surface.

According to the present disclosure, if the vehicle batteries (e.g., the tractor side battery packs) are fully charged during regenerative braking, then power can then be diverted to the trailer if equipped with battery packs (e.g., the trailer side battery packs) to store additional energy. If no battery packs are equipped on the trailer, the energy can then be fed back through to the tractor to increase the energy storage in the BEV battery packs and/or may be discharged so as not to overcharge the vehicle battery pack if already fully charged.

According to the present disclosure, the inductive charging pads( ) may be mounted to either the chassis or frame in the rear section of the tractor and the trailer may have inductive charging pad(s) mounted to the trailer frame so as when the unit is moving straight, the pads are in alignment.

According to the present disclosure, when the truck pulling the trailer is not at a full state of charge, the vehicle may request the power from the regenerative braking of the trailer axle or axles or from the battery packs mounted on the trailer via the communication signal. This may allow the BEV to increase their range from another source connected to the vehicle which will allow for capturing additional energy from the system while in motion and not confined to being stationary.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (just X, or just Y, or just Z) and multiple items (i.e., {X and Y}, {X and Z}, {Y and Z}, or {X, Y, and Z}). “At least one of” is not intended to convey a requirement that each possible item must be present.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A system for charging a battery electric vehicle having a tractor and a trailer, the system comprising:
a regenerative braking system configured to generate energy during deceleration of the battery electric vehicle;
a tractor side battery pack;
a trailer side battery pack;
an inductive charging device configured to transfer energy between the tractor side battery pack and the trailer side battery pack; and
a battery management system,
wherein the battery management system is configured to control a flow of energy between the regenerative braking system, the tractor side battery pack, and the trailer side battery pack based on a state of charge of the tractor side battery pack, a state of charge of the trailer side battery pack, or both the state of charge of the tractor side battery pack and the state of charge of the trailer side battery pack.

2. The system of claim 1, wherein the inductive charging device comprises a first inductive charging pad on the tractor and a second inductive charging pad on the trailer.

3. The system of claim 2, wherein the first inductive charging pad is mounted on an upward facing surface of a rear section of the tractor and the second inductive charging pad is mounted on a downward facing surface in a forward section of the trailer, and
wherein the first inductive charging pad and the second inductive charging pad are aligned with the first inductive charging pad located below the second inductive charging pad when the tractor and the trailer are in an axially straight alignment.

4. The system of claim 2, wherein the first inductive charging pad and the second inductive charging pad each comprise more than one inductive charging pad.

5. The system of claim 1, wherein the trailer side battery pack is mounted on a lower surface of the trailer.

6. The system of claim 1, wherein the battery management system is configured to:
determine the state of charge of the tractor side battery pack; and
request energy from the regenerative braking system or from the trailer side battery pack if the state of charge is below a predetermined level.

7. The system of claim 1, wherein the battery management system is configured to:
transfer energy from the regenerative braking system or from the trailer side battery pack to the tractor side battery pack if the state of charge of the tractor side battery pack is below a predetermined level;
transfer energy from the regenerative braking system to the trailer side battery pack if the state of charge of the tractor side battery pack is above a predetermined level and the trailer side battery pack is below a predetermined level; and
disable the regenerative braking system thus stopping generation of energy if the state of charge of the tractor side battery pack is above a predetermined level and the state of charge of the trailer side battery pack is above a predetermined level.

8. The system of claim 7, wherein the predetermined level of the tractor side battery pack and the predetermined level of the trailer side battery pack each represent a fully charged state for the respective battery pack.

9. The system of claim 1, wherein the system is configured to operate while the battery electric vehicle is in motion.

10. The system of claim 1, further comprising a switch, the switch configured to control the flow of energy between the regenerative braking system, the tractor side battery pack, and the trailer side battery pack.

11. The system of claim 1, further comprising a brake resistor configured to discharge energy generated by the regenerative braking system when the state of charge of the tractor side battery pack and the state of charge of the trailer side battery pack are each at a fully charged state.

12. A method for charging a battery electric vehicle having a tractor and a trailer while the battery electric vehicle is in motion, the method comprising:
determining a state of charge of a tractor side battery pack;
determining a state of charge of a trailer side battery pack;
transferring energy from the trailer side battery pack or from a regenerative braking system to the tractor side battery pack based on the state of charge of the tractor side battery pack being below a predetermined level; and
transferring energy from the regenerative braking system to the trailer side battery pack based on the state of charge of the tractor side battery pack being above a predetermined level and the state of charge of the trailer side battery pack being below a predetermined level.

13. The method of claim 12, further comprising disabling the regenerative braking system based on the state of charge of the tractor side battery pack and the state of charge of the trailer side battery pack.

14. The method of claim 12, further comprising transferring energy with an inductive charging device having a first inductive charging pad mounted on the tractor in axial alignment with a second inductive charging pad mounted on the trailer.

15. The method of claim 14, further comprising mounting the first inductive charging pad to an upward facing surface of a rear section of the tractor and mounting the second inductive charging pad to a downward facing surface in a forward section of the trailer.

16. The method of claim 12, wherein the predetermined level of the tractor side battery pack and the predetermined level of the trailer side battery pack each represent a fully charged state for the respective battery pack.

17. The method of claim 12, wherein the predetermined level of the tractor side battery pack is 80% of a rated capacity of the tractor side battery pack and the predetermined level of the trailer side battery pack is 80% of a rated capacity of the trailer side battery pack.

18. The method of claim 12, further comprising performing the method while the battery electric vehicle is in motion.

19. The method of claim 12, further comprising balancing energy generated by the regenerative braking system between the tractor side battery pack and the trailer side battery pack.

20. A vehicle comprising:
a tractor;
a trailer coupled to the tractor;
a first battery pack on the tractor;
a second battery pack on the trailer;
an inductive charging device configured to transfer energy between the first battery pack and the second battery pack; and
a control system including a microprocessor, the control system configured to:
determine a state of charge of the first battery pack,
determine a state of charge of the second battery pack,
transfer energy from a regenerative braking system or from the second battery pack to the first battery pack if the state of charge of the first battery pack is below a predetermined level,
transfer energy from the regenerative braking system to the second battery pack if the state of charge of the first battery pack is above a predetermined level and the second battery pack is below a predetermined level, and
disable the regenerative braking system thus stopping generation of energy if the state of charge of the first battery pack is above a predetermined level and the state of charge of the second battery pack is above a predetermined level.
